(19) United States
(12) Patent Application Publication
(10) Pub. No.: US 2011/0039252 A1
(43) Pub. Date: Feb. 17, 2011

(54) Mobile Teacher Demonstration Table

(75) Inventor: Roger Moore, Brandon, MS (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: SHELDON LABORATORY SYSTEMS, INC., Crystal Springs, MS (US)

(21) Appl. No.: 12/540,536

(22) Filed: Aug. 13, 2009

(51) Int. Cl. G09B 25/00; A47B 39/00

(52) U.S. Cl. 434/429; 434/432

(57) ABSTRACT

A mobile teacher demonstration table is disclosed which has a cut-out portion making it capable of coupling with a laboratory table having a projecting portion. This cut-out portion provides for easier access to the fixtures of a laboratory table, such as gas, air, vacuum, and water lines.

### FIELD OF THE INVENTION

The present invention relates generally to laboratory tables and more specifically to a mobile teacher demonstration table useful for demonstrating laboratory experiments to various students in a classroom.

### BACKGROUND OF THE INVENTION

Teachers frequently demonstrate science experiments for their students in the course of teaching. There are various ways that teachers can demonstrate how to properly perform the experiments. One such setup is on a fixed laboratory table or desk at the front of a classroom with students gathering close by to watch a demonstration of the experiment before returning to their own tables to perform the experiment. However, there are many problems with this approach. One problem is that the students often have a difficult time remembering the steps once they return to their own tables. Also, in the case of crowded classrooms, it may be difficult for students to hear or see the teacher perform the experiments.

Teachers may also use a mobile teacher demonstration table to demonstrate experiments for students. These tables generally are large laboratory tables on wheels which sometimes have features such as rod sockets for use in setting up experiments, such as chemistry experiments which use a laboratory support rod setup. Most mobile teacher demonstration tables, however, are not able to get close to the student laboratory tables, thus making it difficult for the teacher using the mobile table to have access to fixtures, such as gas, water and vacuum lines, which may be needed in the course of the experiment.

### SUMMARY OF THE INVENTION

The present invention overcomes the limitations of the prior art laboratory demonstration tables by providing a mobile teacher demonstration table for use in lectures and laboratory experiments which has a countertop having a complementary shape to a second laboratory table, such as a student laboratory table. The mobile teacher demonstration table can dock or couple with a student table, allowing the teacher to bring the demonstration to the students at their laboratory table. The teacher can then use the utility fixtures or laboratory equipment that is already present at the students' table.

The underlying countertop support structure of the mobile teacher demonstration table both supports the countertop and includes means for making the demonstration table mobile, such as wheels. In a preferred embodiment of the invention, the table can have rod sockets for receiving laboratory support rods for use in experiments, a storage area beneath the countertop for use in storing papers or laboratory equipment, or countertop extensions on the sides which can fold up to allow for additional space when needed or fold down to make the mobile teacher demonstration table more mobile and easy to maneuver about a classroom if spacing is tight.

### BRIEF DESCRIPTION OF THE DRAWINGS

A more complete appreciation of the present invention, and many attendant advantages thereof, will be readily understood by reference to the following detailed description of the invention when considered in connection with the accompanying drawings.

FIG. 1 illustrates a perspective view of the mobile teacher demonstration table from above and to the side from the teacher's side of the table.

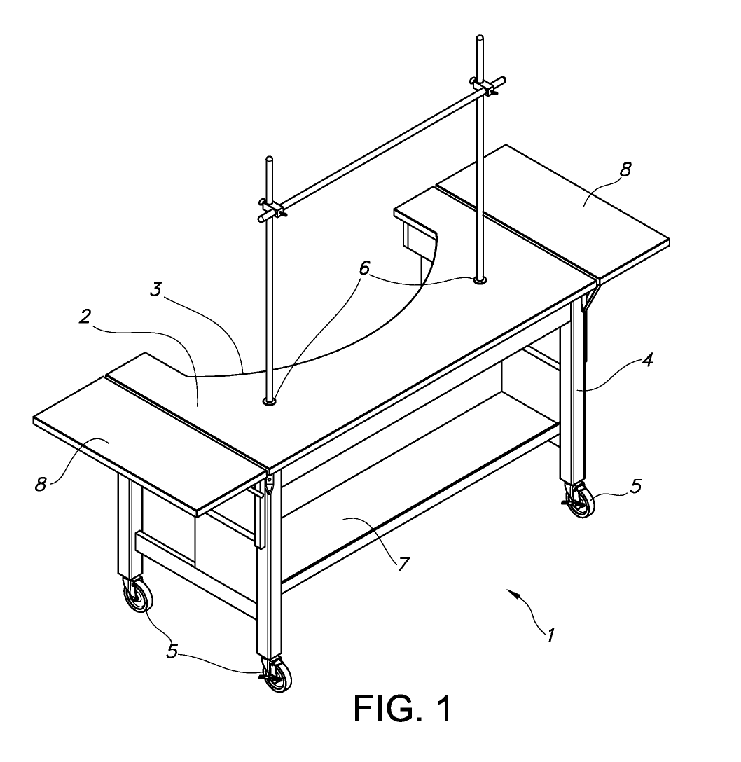

FIG. 2 illustrates the mobile teacher demonstration table from above the table and from the side which would be coupled with another laboratory table.

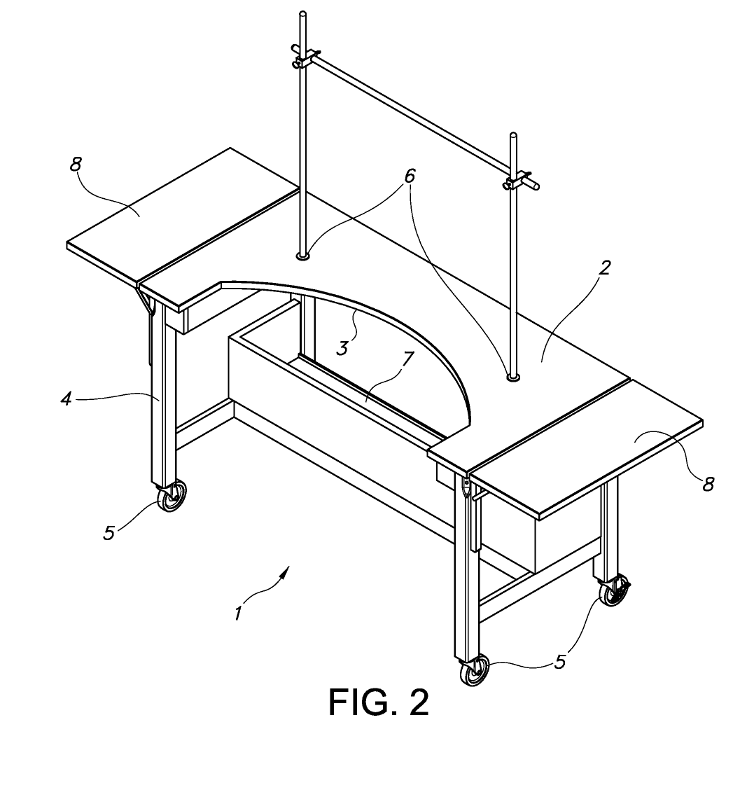

FIG. 3 illustrates a perspective view from beneath and to the side of the mobile teacher demonstration table.

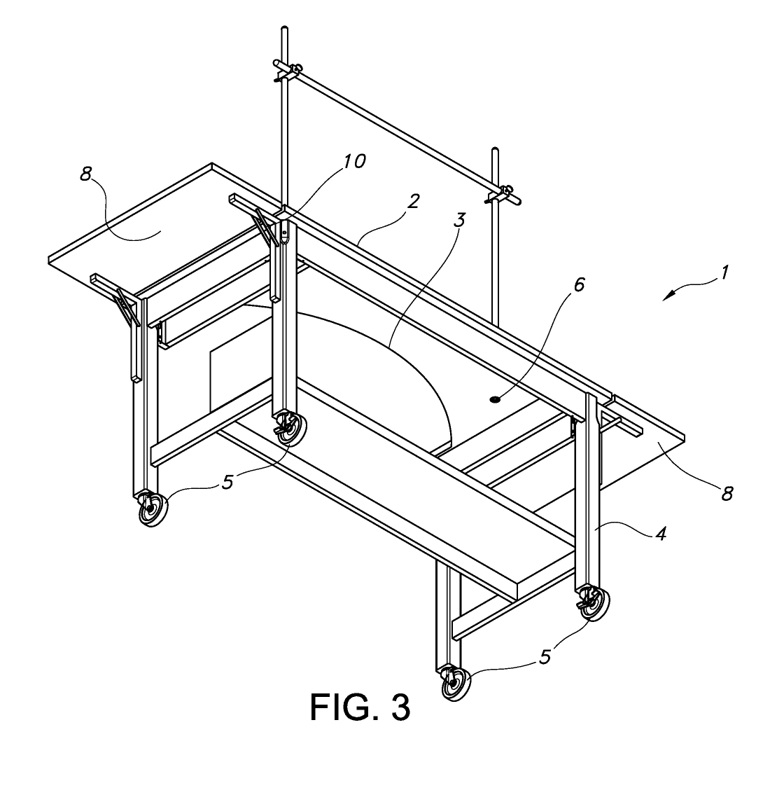

FIG. 4 illustrates the mobile teacher demonstration table coupled with a laboratory table.

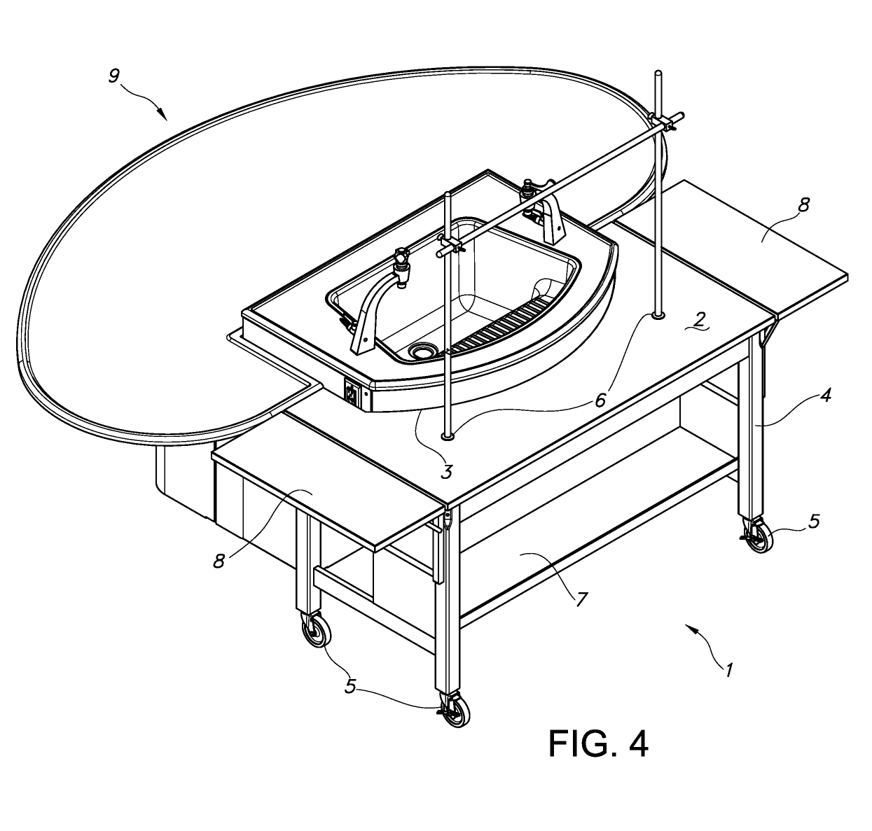

### DETAILED DESCRIPTION OF THE INVENTION

Referring to the drawings, there is shown a mobile teacher demonstration table 1 to be used by a teacher in a laboratory classroom. Due to the mobile nature of the mobile teacher demonstration table 1, demonstrations can be prepared in a prep room and brought into the classroom or laboratory. The mobile teacher demonstration table 1 is also capable of coupling with a student laboratory table or other shaped laboratory table to allow access to gas, water, vacuum or other fixtures needed in performing or demonstrating experiments. The mobile teacher demonstration table 1 has a countertop 2 having a complementary cutout shape 3 allowing for docking or coupling with a protruding section of a second laboratory table 9. The mobile teacher demonstration table 1 also has a countertop support structure 4 having four legs in the preferred embodiment shown, although it could have more or fewer legs in alternative embodiments.

In a preferred embodiment of the invention, the countertop support structure 4 for the countertop 2 has a storage space 7 shown as comprising a shelf with a back, although the storage space 7 could also have drawers, shelves or other storage means known in the art. The mobile teacher demonstration table 1 also may have rod sockets 6 for allowing for insertion of laboratory rods for a setup of experiments requiring such a structure. Also as shown in a preferred embodiment of the invention, the mobile teacher demonstration table 1 can have countertop extensions 8 attached to the sides of the laboratory table allowing for expansion of the table surface when extended, but also capable of collapsing to reduce the surface area and make the table more maneuverable. The countertop extensions 8 can be attached to the mobile teacher demonstration table 1 by use of brackets 10, as shown, or hinges. It would be clear to someone having ordinary skill in the art that there are other ways by which the countertop extensions 8 could be attached to the countertop 2 which would also serve the purpose of the invention.

For a demonstration, the teacher would simply bring the mobile teacher demonstration table 1 to the students' table and position the mobile teacher demonstration table 1 such that the protruding section of the students' table is positioned within the complementary cut out in the countertop 2 of the mobile teacher demonstration table 1. The teacher can then access the fixtures, equipment, and utilities of the students' table. After completion of the demonstration, the teacher can then simply move the mobile teacher demonstration table 1, to another student table as needed.

The current preferred embodiment of the invention can be of any width, height, or depth to accomplish the means of providing a mobile teacher demonstration table 1 with the capability to couple to a second laboratory table 9. It should be understood that the foregoing represents merely an exemplary embodiment of the present invention, and the various changes and modifications can be made in the arrangements, details and construction of the elements described and shown here, without departing from the spirit and scope of the present invention.

We claim:

1. A mobile teacher demonstration table for use in lectures and laboratory experiments, said mobile teacher demonstration table comprising:
a. a countertop, said countertop having a complementary shape to a second laboratory table;
b. a countertop support structure, said countertop support structure configured to elevate said countertop to the height of said second laboratory table; and
c. devices affixed to said countertop support structure allowing for mobility of the mobile teacher demonstration table.

2. The mobile teacher demonstration table of claim 1 wherein said countertop further comprises rod sockets for receiving laboratory rods;

3. The mobile teacher demonstration table of claim 1 further comprising a storage area below said countertop;

4. The mobile teacher demonstration table of claim 1 further comprising countertop extensions configured to fold away when not in use.
